(19) United States
(12) Patent Application Publication
(10) Pub. No.: US 2007/0086309 A1
(43) Pub. Date: Apr. 19, 2007

(54) Method and Device for High Density Optical Disk Data Storage

(75) Inventor: Jianwen Yang, Miami, FL (US)

Correspondence Address: NEW SPAN OPTO-TECHNOLOGY INC., 9380 SW 72ND STREET, B-180, MIAMI, FL, 33173, US

(73) Assignee: NEW SPAN OPTO-TECHNOLOGY INC., Miami, FL (US)

(21) Appl. No.: 11/163,351

(22) Filed: Oct. 16, 2005

(51) Int. Cl. G11B 7/135

(52) U.S. Cl. 369/112.01

(57) ABSTRACT

This invention describes a novel coding and implementation techniques for high-speed high-density optical disk data storage. Multiple narrowband spectral beams, either coherent or non-coherent, are combined together by optical fiber couplers or lenses assembly and are then focused into a photosensitive film with diffraction limited spot size through a specially designed hybrid diffractive/refractive lens with extended depth of focus, so that the beam size remains diffraction limited size in the whole depth of the recording medium volume. Multiple reflection gratings which are respectively corresponding to these used spectral bands are recorded in the medium through interferences between the incident beams and the reflected beams from a reflection mirror which is attached at the back surface of the recording film. The reflected beam from the reflection mirror can also be replaced by a second focused beam (without using reflection mirror) with the beam splitted using an optical fiber splitter from the incident recording beam and using an identical lens with the same extended depth of focus property. By using white light to readout these gratings, using a spectrometer or multi-wavelength reader to acquire the reflected light, and using algorithms to analyze the spectrum, the recording information is recovered.

### FIELD OF THE INVENTION

The present invention relates to high-speed high-density optical disk data storage, and in particular to a system and method for storing multiple-bits of data at a single diffraction limited pit.

### BACKGROUND OF THE INVENTION

High-speed high-density data storage technologies are required in next generation information superhighway and military warfare because of increased demand in information access. The data storage technology is critical for fast computing and processing for targeting, time critical communication and control, and real-time sensor-to-shooter operations. The data storage is also critical for fast access to large intelligent database for other command and control operations. Furthermore, high-density data storage is highly demanded in computer and network applications. All these applications place high requirement on data storage systems namely high storage capacity, fast data access, and rugged system packaging.

There are significant advancements in disk data storage technology in recent years. The traditional magnetic disk storage has now reached its performance limitations. Higher storage density becomes harder and harder to achieve on these magnetic disks and close head-to-media spacing makes high density drives no longer removable. To enhance the stored data integrity and achieve high storage density with large head-to-media spacing, optical disk storage is preferred.

Optical data storage is currently a hot research topic. There are constant developments to improve data storage density such as holographic data storage, optical disk data storage (evolution of DVD), and nano-structure technique such as near field micro-hole diffraction. Holographic data storage can demonstrate extremely high storage density using LiNbO₃, BaTiO₃, photopolymers, liquid crystals, Ge-doped silica glass, protein recording media, etc. Despite the high storage density achieved, the holographic storage requires critical vibration-free recording and readout setups. Many of them suffer from destructive readout problems. Volume holographic storage is presently far from commercial uses.

Optical disk data storage would be considered as preferred commercial technique since the disk architecture is well accepted, as long as the storage density bottleneck problem is solved. The data storage media under research and commercial applications include magneto-optic media, dye-polymer, phase change media, etc. The disk storage density bottleneck problem is mainly the storage coding technique. Of course, it is also related to available recording material. The conventional coding is binary coding achieved by recognizing different reflected light levels (high or low in binary format) from the storage disk (magneto-optic disk, dye-polymer disk, or phase change disk). The recording density is thus limited by the focused optical spot size used for recording and readout. The minimum focused spot size is the diffraction limited spot size from the focusing lens unit at the designated optical wavelength.

In addition, some novel technologies are being pursued in parallel towards accomplishing higher capacities per disk and higher data transfer rates. Several unconventional long-term optical data storage techniques promise data densities greater than 100 Gb/in² and perhaps even exceeding Tb/in². These include near-field optics, sub-Rayleigh criterion optics and probe storage techniques that hold promise for new optical data storage technologies. All these techniques can be considered as near field techniques since the storage pit size is further reduced that requires near field recording and readout. Employing parallel readout to an array of such optics is way to increase read/write access time and data throughput. Thus, it can be readily adapted into this technology. Although there have demonstrated some proof-of-principle results, a number of issues must be addressed before these technologies can be considered for commercial applications, such as overall system reliability, bit stability, tip/medium wear, limits of data rate, signal to noise ratio, and cost. These near field techniques even if successful would require high-resolution servo scanning that is very costly. Furthermore, the high precision scan readout is slow limited by the trade-off between scanning speed and scanning accuracy. Such technique cannot well use high-speed electronics to increase data access rate since the limitation comes from the readout scanning. Thus, the data access rate would be a major concern.

Reducing storage pit size is currently a general technique for improving data storage density (except the in-mature holographic storage technique). However, the data coding is still binary code. Such trend of reducing pit size increases recording and readout difficulty that makes newer technologies more difficult to be commercially implemented.

A high-density disk storage concept using micro holographic multiplexing method has been reported [e.g., H.J. Eichler, P. Kuemmel, S. Orlic, A. Wappelt, “High-density disk storage by multiplexed microholograms,” IEEE J. of Selected Topics in Quant. Electr. 4, 840-849 (1998)]. That method combines the bit-oriented storage of conventional optical disks and volume storage from the holographic approach, and thus it benefits from both technologies. This concept has been proved experimentally through generation of micro holograms with about 2 micron diameter, wavelength multiplexing by three-color hologram recording and picoseconds recording in a commercial photopolymer.

Although with successful demonstration of the micro holographic multiplexing method for high density data storage, there are some limitations that may obstruct this concept from practical commercial systems. First, the hologram recording needs highly coherent light sources (laser lines). For multiple bits storage on a single spot, the laser line number must be the same as the bit number. It is difficult to find multiple laser lines with nearly equal wavelength intervals in the sensitivity range of a recording material. The cost of using these lasers is high. Another issue is that the recording spot size cannot remain the same diffraction limited size along the propagation path of the beam in the recording medium. It requires a certain thickness of a medium for multiplexing the multiple holograms. This thickness will be much larger than the Rayleigh length of a laser waist. The divergent beam at the recording volume will cause cross talks among adjacent pits. This effect limits the achievable recording density.

### OBJECTS OF THE INVENTION

It is therefore an object of the present invention to provide an optical disk data storage system that has high storage density and fast access rate by coding multiple bits on a single pit that may be a diffraction limited pit.

It is another object of the present invention to provide a novel optical disk data storage system that is compatible with existing optical disk drivers such as CD-ROM and DVD for data recording and readout.

It is another object of the present invention to provide an optical disk data storage system that can use various light sources including both coherent and non-coherent sources for recording and readout so as to reduce the system cost.

It is yet another object of the present invention to apply a specially designed objective lens system with property of extended depth of focus to create diffraction limited spot size with long focal depth of the recording beam for minimizing crosstalk between stored pits in a thick storage film.

### SUMMARY OF THE INVENTION

According to the present invention, there is described a novel coding and implementation techniques for high-speed high-density optical disk data storage. Multiple narrowband spectral beams, either coherent or non-coherent, are combined together by optical fiber couplers or lenses assembly and are then focused into a photosensitive film with diffraction limited spot size through a hybrid diffractive/refractive lens. The focal depth of the focused beam is extended due to the use of the specially designed hybrid diffractive/refractive lens, so that the beam size remains diffraction limited size in the whole depth of the recording medium volume. Multiple gratings which are respectively corresponding to these used spectral bands are recorded in the medium since a reflection mirror which is attached at the back surface of the recording film reflects back the incident beam so that the incident and the reflected beams interfere each other to generate the gratings. The reflected beam from the reflection mirror can also be replaced by a second focused beam (without using reflection mirror) with the recording beam splitted using an optical fiber splitter from the incident recording beam and using an identical lens with the same extended depth of focus property. By using white light to readout these gratings and using a spectrometer or multi-wavelength reader to analyze the reflected light, some peaks corresponding to these recording wavebands can be found. By proper spectral curve operations, the recording information is recovered from this reflected spectrum. This present invention can write and read multiple bits information on a single storage pit, which is usually only one bit based on conventional storage technologies.

### DESCRIPTION OF THE DRAWINGS

FIG. 1 is a schematic, showing the recording of the reflection grating in the recording medium using a pseudo non-diffracting beam with extended depth of focus property.

FIG. 2a shows the focal depth property of the hybrid diffractive/refractive lens for extending the depth of focus.

FIG. 2b shows the focal depth property of a conventional objective lens.

FIG. 3 is a comparison of on-axis focused light intensity distribution between a conventional lens and the hybrid lens with extended depth of focus.

FIG. 4 shows achromatic property of the hybrid lens with extended depth of focus.

FIG. 5 is a schematic of multi-wavelength data recording to achieve N bits per pit optical storage density.

FIG. 6 is a schematic of combining LEDs and filters to generate multiple narrowband spectral lines.

FIG. 7 is a schematic of generating multiple narrowband spectral lines using white light source and dispersive element.

FIG. 8 shows an example of reflection spectrum recording nine bits in one storage pit.

FIG. 9 shows a calibration curve of reflectance change with recording exposure amount.

FIG. 10 is a schematic of the spectral coded read/write disk driver.

FIG. 11 is a picture of the spectral coded read/write head adjustment on an existing CD-ROM or DVD disk head.

FIG. 12 is a schematic of a read-only disk drive.

### DETAILED DESCRIPTION

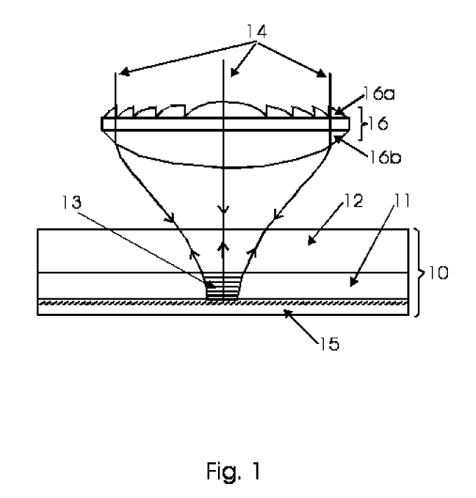

FIG. 1 is a schematic showing the recording of reflection grating in the recording medium using a pseudo non-diffracting beam with extended depth of focus property. The storage disk 10 can be created by coating a photosensitive film 11 on the substrate 12 with size of a standard CD/DVD disk. Dupont's photopolymer materials, such as HRF-700 and HRF-800, are examples of currently available candidates of recording medium. Reflection grating 13 can be recorded in the film by the illumination of a monochromatic or narrowband beam 14 along with a high reflectivity reflection mirror 15. This way, grating recording requires only one beam. It has minimal requirement on light coherent length since it minimized optical path difference between the incident beam and the reflected beam. Lower cost semiconductor laser or even narrowband spectral lines obtained from white light sources can be used. The illuminating beam first enters the recording medium 11 and then is reflected back from the reflection mirror 15. The interference between the incident beam and the reflected beam generates a reflection grating 13 in the medium volume. The grating reflection efficiency is directly determined by the exposure amount of incident beam. Using wavelength multiplexing technique, a series of reflection gratings can be recorded at a common pit by different wavelengths (incident at the same perpendicular direction). The pit can be diffraction limited size on the film surface while its depth can be extended through the film volume for efficient grating reflection when a diffractive (16a)/refractive (16b) hybrid optical element 16 is used for extending focal depth. The long grating interaction length can minimize wavelength channel crosstalk because of its excellent wavelength selectivity. During readout, the mirror 15 is removed. The spectral diffraction of each grating is determined by its correspondent beam of recording wavelength. The reflection peak location may shift due to film shrinkage during post-processing. A white light source can be used for readout.

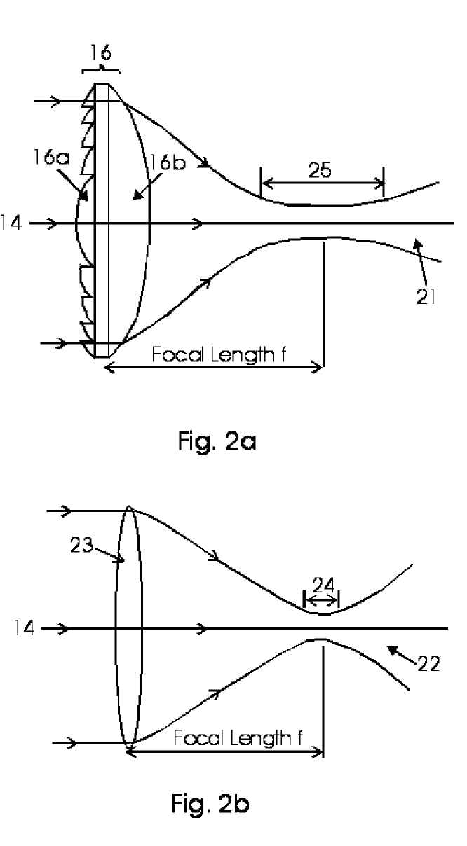

FIGS. 2a and 2b show a comparison of focal depth property between an extended focal depth lens 16 and a conventional lens 23. To achieve long propagation depth of at least two times the film thickness (forward and return) of the diffraction limited recording beam spot, the present invention uses pseudo non-diffracting beam 21 instead of conventional Gaussian beam 22. Conventional Gaussian beam 22 has very limited propagation depth 24 at diffraction limited spot size. Pseudo non-diffracting beam 21 on the other hand can maintain its small central spot for a substantially long propagation distance 25 with minor beam spreading in transversal direction. The pseudo non-diffracting beam can be achieved by using a diffractive/refractive hybrid lens 16 which is fabricated by using a specially designed diffractive optical element 16a attached on a conventional objective lens 16b as shown in FIG. 2a.

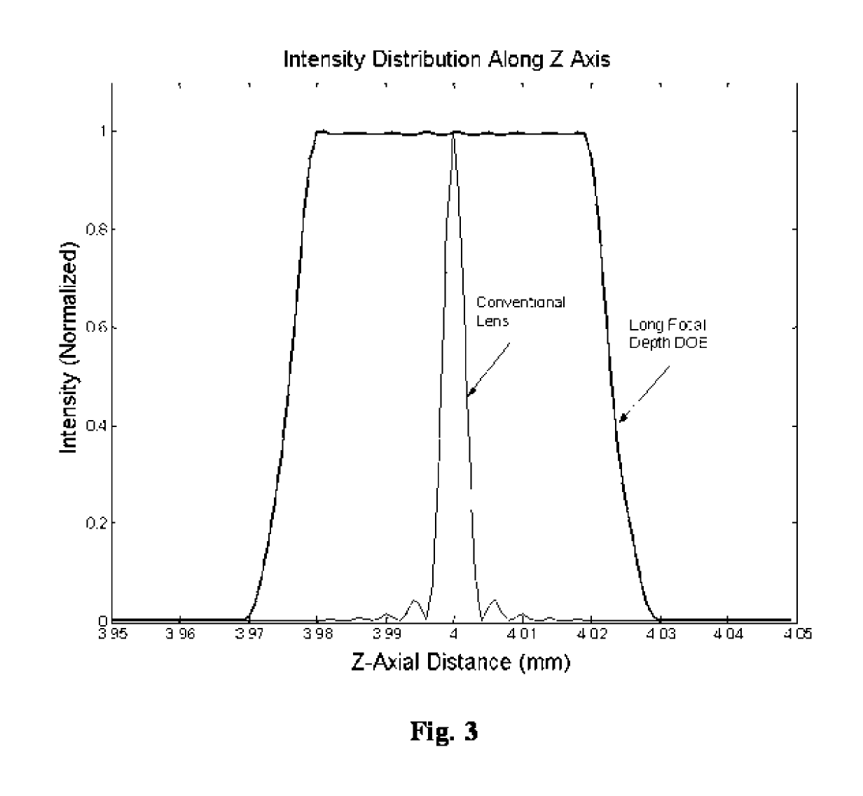

Various existing optimization algorithms for diffractive optical element design can be adopted to design the pseudo non-diffracting beam shaper 16a. FIG. 3 shows an embodiment on-axis light intensity distribution of a designed non-diffracting beam shaper based on conjugate-gradient algorithm, where the conventional one is also shown for comparison.

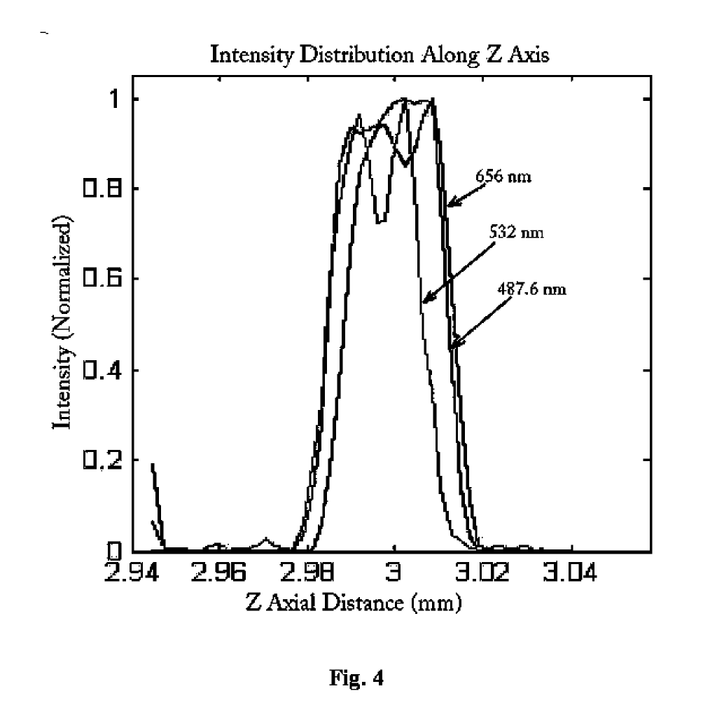

Attaching the designed non-diffracting beam shaper 16a to a refractive lens 16b will generate the appropriate power hybrid refractive-diffractive lens 16 with extended focal depth. Due to opposite chromatic dispersion between diffractive element and refractive element, it is possible to obtain achromatic lens by combining the two types elements. When material specifications and geometric parameters of the adopted refractive lens are properly designed, perfect achromatic property can be achieved so that the hybrid lens is suitable to work in a wide waveband. FIG. 4 shows the achromatic property for three wavelengths of 656 nm, 532 nm, and 487.6 nm, as an example.

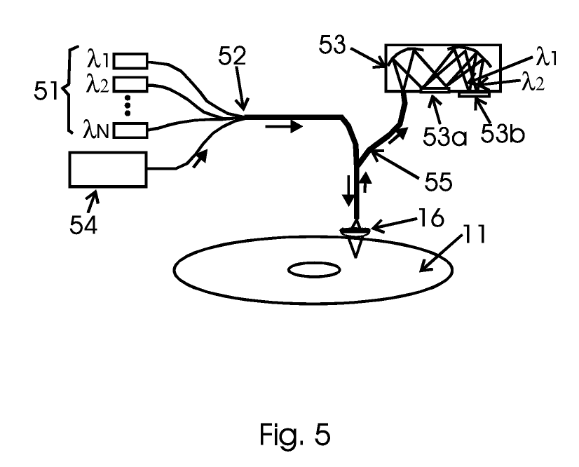

One embodiment schematic of multi-wavelength recording system is shown in FIG. 5. The multi-wavelength (say N) laser sources 51 can be combined from N single wavelength laser lines using a fiber coupler 52 and then focused to about diffraction limited spot size on the photosensitive film 11. In the focusing optics, the specially designed achromatic refractive/diffractive hybrid optical element 16 is added to generate a pseudo non-diffracting beam for recording and readout. This will let the beam keeping diffraction limited size in the photosensitive medium volume 11.

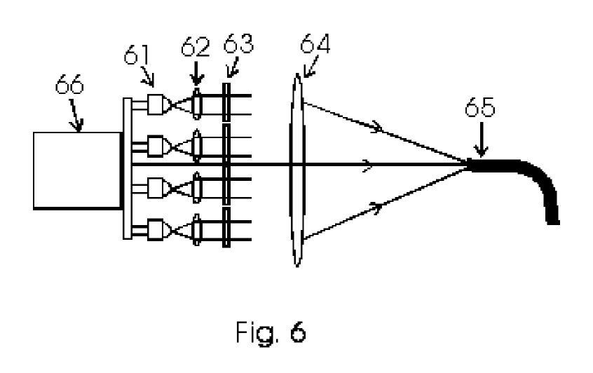

FIG. 6 is a schematic diagram showing another method to obtain these spectral lines using a set of LEDs 61 each collimated with a lens 62 and filtered with a narrowband filter 63. The central transmission peaks of these filters should be properly separated to control crosstalks during gratings reflection readout. It is preferred that LEDs have high emission power at their relevant filter's transmission peaks. Then we can use a large aperture lens 64 to combine all filtered beams together and couple them into a single mode fiber 65 to deliver recording light beams to the hybrid lens. The switching ON/OFF of each light beam can be modulated separately by an electronic controller 66.

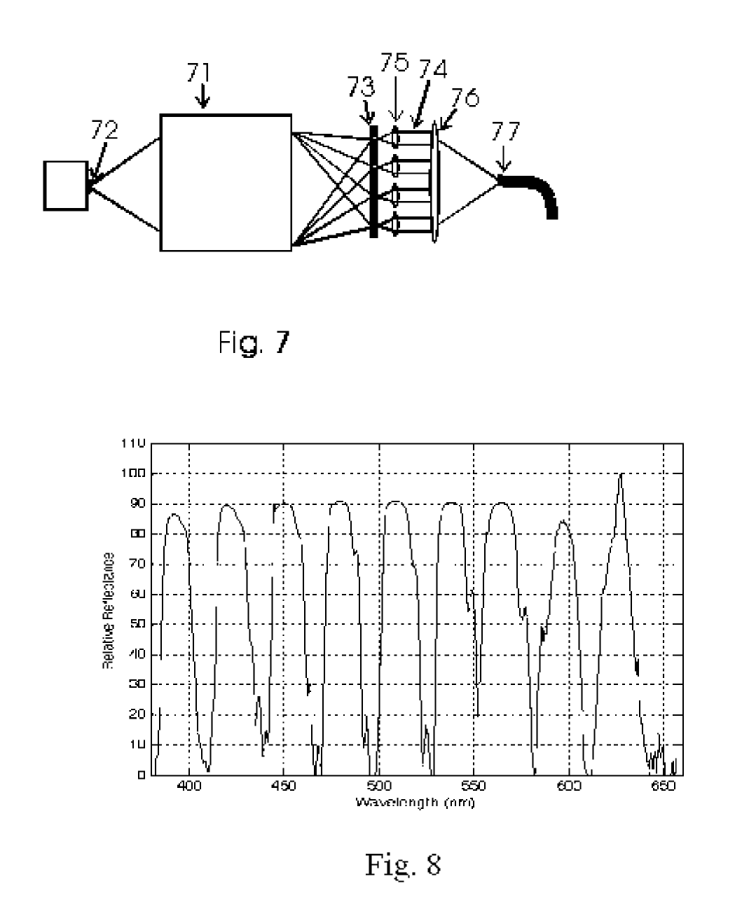

There is still another method shown in FIG. 7 that is to firstly use a dispersive element 71 to disperse a spot from the white light source 72. The wavelength spectrum of white light source is spread along one direction on the surface of a dynamic mask 73, which can be a spatial light modulator (SLM). By switch ON proper pixels of the SLM, expected narrow spectral lines 74 can be selected to transmit. After collimating these narrow spectral light beams by using collimation lenses 75, all these light beams are combined together with a big lens 76 and couple into the fiber 77.

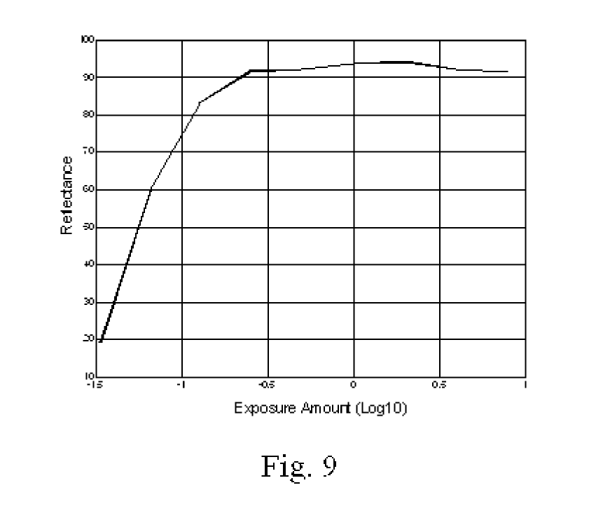

Upon exposing to the multiple wavelengths light, gratings are generated in the photosensitive film 11. When illuminated with a white light source (54 in FIG. 5) during readout (removing the reflection mirror), the spectroscopic reflectance is determined by the recorded reflection gratings. The reflected light components are coupled into the output optical fiber 55 and can be detected by a simple micro spectrometer system or multi-wavelength reader 53 (see FIG. 5) that include dispersion elements 53a, a photodetector array 53b, and processing electronics. We can modulate intensity of each light spectral line with either binary signal or multiple levels signal. By binary modulation, each recording wavelength represents one bit of the data. FIG. 8 shows an example of reflection spectrum recording nine bits on one pit. By multiple levels modulation of the recording spectral lines, each reflected peak represents multiple bits (say M bits) of information and total N peaks represent M×N bits of information. To achieve gray level recording, the relationship between reflectance and exposure dosage needs to be calibrated. FIG. 9 shows such a calibration curve as an example with arbitrary exposure unit. The M×N bits of information can thus be recorded on the photosensitive film within diffraction limited local spot size. The storage density is M×N times of the present DVD storage density.

To retrieve the recorded data information from the reflection spectral curve, data processing on the spectral curve can be carried out. If the spectrum is recorded by binary signal modulation, simply thresholding the spectral data at corresponding wavelength locations can recover the recorded information represented by a serial of binary bits.

If the recording signal is modulated in gray levels, the recorded information can be recovered by comparing detected spectral information, comparing spectrum curve curvatures, local spectrum curve slopes, and relative intensities in each wavelength region, correct spectral-coded information can be recognized independent of some white-light intensity fluctuation and slight readout spot misalignment. Here the readout is not based on determining the absolute transmittance at each wavelength since that is sensitive to readout alignment error and light source intensity fluctuation. Comparing spectrum curve curvature, slope, and relative intensity is a novel technique that offers reliable readout. The readout color (or spectral) is unique if we use conventional chromaticity evaluation technique. Although there are a lot of spectral details, the readout needs to employ grouping technique to identify unique features in each wavelength and use table lookup to minimize the recognition processing.

The spectral-coding concept uses different detailed spectroscopic contents on a recording media to represent different data. Different detected intensity patterns will be properly compared by an electronic processing circuit and to establish its corresponding binary value. Using photodetector array is similar to using many readout heads in parallel. This approach on spectral identification can be quite accurate by comparing many spectral data. The speed of spectral identification can be fast using advanced high-speed electronics including multi-chip modules and using table look-up technique. The proposed spectral coded storage allows further improvement of data access rate through electronic circuit improvement. Since each recording pit stores multiple bits of information, we can expect minor difference on spectral curve to represent different data. Spectral curve fitting and colorimetry evaluation of local curve curvature, slope, and comparison of relative intensities can quantify the spectral details with excellent accuracy.

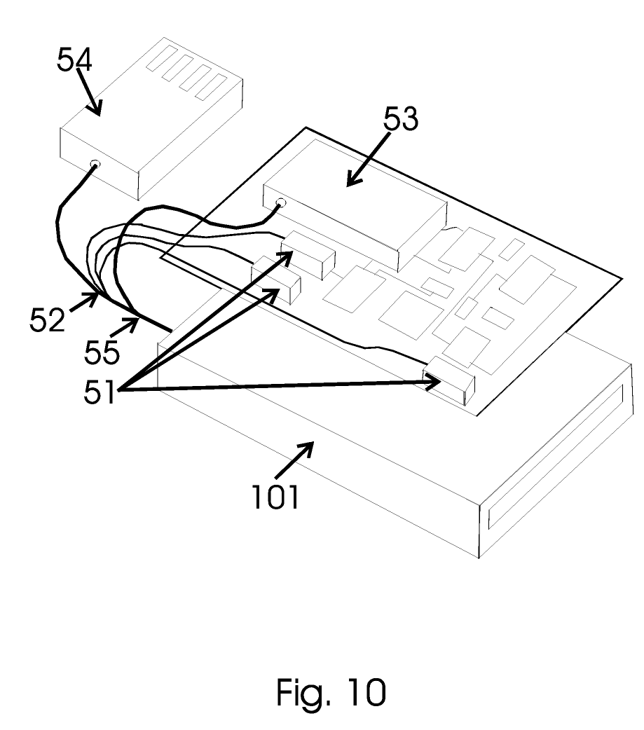

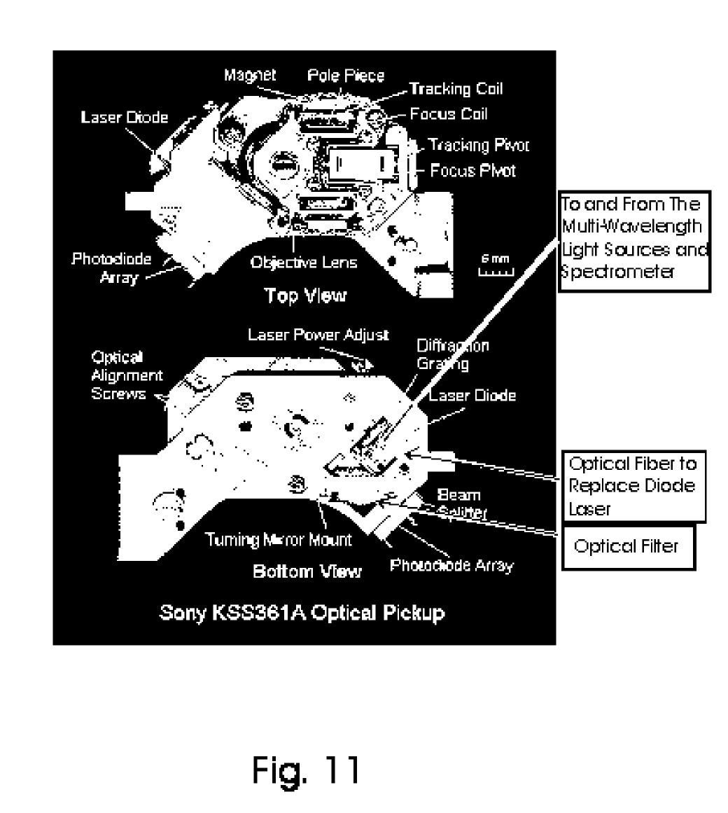

The present invention of spectral coded data read/write system as shown in FIG. 5 can be implemented as an embodiment shown in FIG. 10, where the read/write head 101 is modified from a existing CD-ROM or DVD-ROM head, and the detailed modifications are schematically shown in FIG. 11. In order to achieve diffraction limited focusing spot size on the disk, the optical fiber must be single-mode at the shortest recording wavelength. This can ensure the fiber is still single-mode at other longer wavelengths.

White light to fiber coupling is another technical challenging issue. We use white light for readout because we can extract more spectral details at wavelengths besides the recording laser wavelengths. This can produce a continuous spectral curve to represent the multiple bits binary data. Because the relatively high lamp power, even with the poorer fiber coupling efficiency, we can still deliver enough white light to the read/write head for spectral readout.

With a single-mode fiber as input and output to the read/write head, we can modify the existing CD-ROM or DVD head for the spectral coded data readout. FIG. 11 shows a picture of the modifications based on an existing CD-ROM head. Our disk head packaging is to replace the diode laser in the existing disk head package by the single-mode optical fiber. The achromatic pseudo non-diffracting beam shaper replaces the original collimation lens. The pseudo non-diffracting beam shaper introduces some weak but unavoidable side lobes in order to improve the depth of focus. It does not affect diffraction behavior in the disk head. The return reflected light from the disk carrying the spectral information is partially reflected by the beam splitter back to the optical fiber (through the diffraction grating and the collimation lens). The collimation lens now functions as focusing lens. The return beam with spectral information is now routed by the fiber to the micro spectrometer for spectral recognition code processing. Another part of return beams transmitted through the beam splitter to the photodiode array (see bottom view of FIG. 11). We insert an optical filter between the beam splitter and the photodiode array to eliminate the effect of dispersion from the other light wavelengths since this photodiode array is designed for a particular red laser wavelength. This way the photodiode can function as usual for the positional tracking control and auto focus control. There is no need to modify the disk spinning hardware and all other control electronics. All we need to add is the evaluation electronics for the micro spectrometer or multi-wavelength reader 53. After adding the micro spectrometer or multi-wavelength 53, the spectral evaluation circuits, and diode laser drivers, the new spectral coded data storage system is formed.

We use the optical fiber to replace the original red laser diode as shown in FIG. 11. This can retain all track alignment and auto focus control of the existing CD-ROM or DVD drive while adding the spectral coded read/write features. When used as spectral coded disk read/write, the readout signal from the photodiode array is not used. The readout code information comes from the micro spectrometer evaluation circuit. The new spectral coded disk drive as shown in FIG. 11 can also function as CD-ROM or DVD drive by simply turning on only the red laser (identical to original diode laser wavelength) and use the original readout signal from the photodiode array. This way the spectral coded disk drive is compatible with the older version disk drive for DVD or CD-ROM readout.

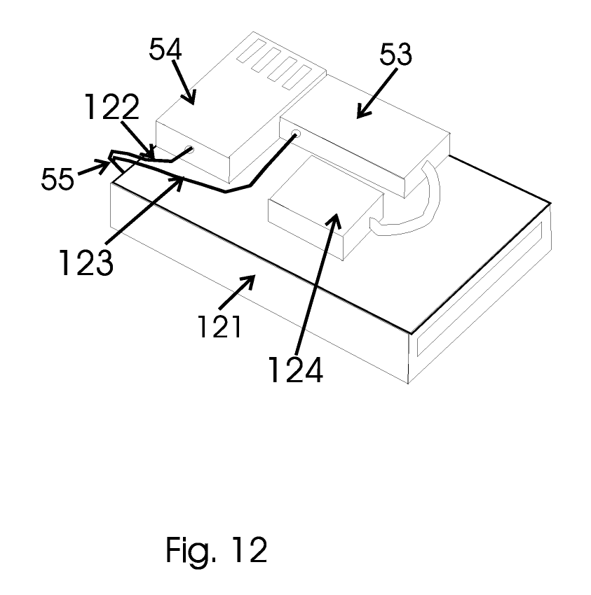

If a multi-wavelength combiner shown in FIG. 6 or FIG. 7 is used as recording light source, the cost of the updated CD-ROM/DVD driver will be low. However, if multi-laser lines with nearly even spreading in a specific waveband are used, the cost may be higher. This is suitable for factory fabrication of mass volume read-only disks. In this case customer would need a read-only disk drive only. This kind of read-only disk drive can be constructed by further simplifying the modified CD-ROM/DVD driver shown in FIG. 10. FIG. 12 shows a schematic of read-only disk driver used for data readout of the present invention. Where, the read head 121 is the same as that of 101 shown in FIG. 10. The white light source 54 is coupled into the read-only head 121 by one fiber branch 122 of a 2-to-1 fiber coupler 55. The reflected light from the storage disk is coupled back into another fiber branch 123 of the 2-to-1 coupler 55 which is connected with a micro-spectrometer or multi-wavelength reader 53. The spectral data is analyzed by a special electronics unit 124 to recover stored information.

What is claimed is:

1. An writable optical data storage device comprising:
an broadband photosensitive storage medium;
a write/read head;
a multiple narrowband spectral lines generating device;
a white light source or wide spectral band light source;
a micro-spectrometer or multi-wavelength reader with spectral acquisition and analysis electronics and programs.

2. The said photosensitive storage medium of claim 1 is a flexible disk whose dimensions can be the same as existing CD-ROM/DVD's for disk compatibility and can also be smaller or larger.

3. The said flexible disk of claim 2 has a broadband photosensitive film with controlled thickness coated on a suitable transparent substrate.

4. The said write/read head of claim 1 can be modified from an existing CD ROM head, where the diode laser in the existing disk head is replaced by a single-mode optical fiber to transfer writing/reading light in and to transfer reflected light out of the head. It can also be a specially designed write/read head.

5. Inside the said write/read head of claim 4, a specially designed diffractive/refractive hybrid lens with extended focal depth replaces the existing lens. The diffractive element can be designed using existing optimization algorithms. By properly selecting parameters of the refractive lens, the hybrid lens can be achromatic for a wide spectral band.

6. Inside the said write/read head of claim 4, the reflected light is coupled back into the single mode fiber and is splitted into the output fiber which is connected to a micro-spectrometer or multi-wavelength reader.

7. Inside the said write/read head of claim 4, the surface of photosensitive film on the disk is placed on the opposite side of the incoming writing light. During writing phase, a reflection mirror is attached onto the photosensitive film to reflect back the writing light on its incoming path so as to generate interference grating in the recording medium volume.

8. The said write/read head of claim 4 retains disk tracking, auto-focus, and auto-alignment components of the existing write/read head.

9. The said multiple narrowband spectral lines generating device of claim 1 comprises of multiple laser lines with different wavelengths spreading over a wide spectral range corresponding to the medium spectral responsive band.

10. These said laser spectral lines of claim 9 are coupled into a single-mode fiber by using a N-to-1 fiber coupler.

11. The light power and ON and OFF of all laser lines of claim 9 are individually modulated by a controller. The control signal is based on the expected storage data information.

12. The said multiple narrowband spectral lines combining device of claim 1 can also be implemented by using a white light source. The spectrum of the white light source is spread by a dispersive device. Expected narrowband spectral lines are selected by using a spatial light modulating device. These spectral lines are combined by a lens assembly and are coupled into a single-mode fiber.

13. The light power and ON and OFF of all spectral lines of claim 12 are modulated by transmittances at relevant locations of the spatial light modulating device based on the expected data information.

14. The said multiple narrowband spectral lines generating device of claim 1 can still be implemented by using a LED array. After filtering the light of each LED with proper bandpass filter, these filtered light beams are collimated and focused to couple into a single-mode fiber.

15. The light power and ON and OFF of all LEDs of claim 14 are modulated by an electronic controller. The control signal is based on the expected data information.

16. The said white light source or wide spectral band light source of claim 1 can be any high brightness light source with abundant spectral contents in the recording light wavebands. The light energy is coupled into a single mode fiber and further coupled together with recording light beams.

17. The said micro-spectrometer or multi-wavelength reader of claim 1 is functioning like any fiber-coupled spectrometer, in which a spectral acquisition and analysis electronic board is installed. The micro-spectrometer or multi-wavelength reader can also be constructed by placing individual photo detectors at relevant spectral line locations of the dispersed spectral to acquire readout spectral intensity.

18. In the spectral analysis electronic board of claim 17, there is a microprocessor for recovering data information from the received spectral data. Some data processing programs, such as curve fitting and calorimetric calculation, are used in the processor.

19. A read-only disk driver comprising:
a read-only head;
a white light source or wide spectral band light source;
a 2-to-1 optical fiber coupler; and
a micro-spectrometer or multi-wavelength reader with spectral analysis electronics and programs.
